(19) United States
(12) Patent Application Publication
(10) Pub. No.: US 2005/0246702 A1
(43) Pub. Date: Nov. 3, 2005

(54) System and method for automatically updating versions of software programs in client computers

(75) Inventors: Pu-Yang Yeh, Tu-cheng (TW); Xu-Liang Guo, Shenzhen (CN)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 11/024,891

(22) Filed: Dec. 28, 2004

(30) Foreign Application Priority Data
Apr. 30, 2004 (TW) 93112197

(51) Int. Cl. G06F 9/44

(52) U.S. Cl. 717/170

(57) ABSTRACT

A system for automatically updating versions of software programs in client computers includes: client computers (1), each including software programs (10) and a version update inquiry module (11); an application server (2) including a version number obtaining module (200), a comparing module (201), a connecting module (202), and an updating module (203); a database (3) for storing version numbers of newest versions of the software programs; and an FTP server (4) for storing the newest versions of the software programs. Each time a software program is operated by a user in a client computer, the version update inquiry module sends an inquiry to the application server. The application server responds by determining whether the current version of the software program is the newest, and updating the software program to the newest version obtained from the FTP server if the current version of the software program is not the newest.

### BACKGROUND OF THE INVENTION

1. Field of the Invention

The present invention relates generally to computerized systems and methods for processing data, and more particularly to a system and method for automatically updating versions of software programs in client computers.

2. Related Art of the Invention

In a typical company or organization, client computers are connected to a network such as a local area network, a wide area network, an intranet, and/or the Internet. Each client computer can download the newest versions of documents from server computers and update the documents. Client application software typically accepts a command for updating a document from a user, and obtains data services by sending a request to a server application running on one of the server computers. To respond to the request from the client computer, the server application compares the data of the current version of the document with those of the newest version, and updates the document in the client computer with the newest version if the two versions are inconsistent. However, the updating is not done automatically as soon as the newest version is available. Instead, the user determines whether or not to update, and then starts the update procedure if desired. In addition, the user may be made to wait an unduly long time while the server application compares the data of the two versions. Thus there is a need for a system and method which can update files and documents in client computers automatically and quickly.

### SUMMARY OF THE INVENTION

Accordingly, a main objective of the present invention is to provide a system for automatically and readily updating versions of software programs in geographically distributed client computers.

Another objective of the present invention is to provide a method for automatically and readily updating a version of a software program in a client computer.

To accomplish the first above-mentioned objective, a system for automatically updating versions of software programs in client computers (hereinafter, “the system”) is provided herein. The system comprises an application server, a file transfer protocol (FTP) server, a database, and a plurality of geographically distributed client computers. Each client computer has one or more computer-executable software programs and a version update inquiry module installed therein. The version update inquiry module is for sending an inquiry to the application server about a version status of a software program when the software program is operated by a user in the client computer. The FTP server stores the newest versions of the software programs. The database server stores a data list which contains version numbers of the newest versions of the software programs. The application server includes: a version number obtaining module for obtaining a version number of a software program operated by the user in a client computer; a comparing module for comparing the version number of the software program in the client computer with the version number stored in the database, and determining whether the version of the current software program is the newest; a connecting module for connecting the application server to the FTP server when the version of the current software program is not the newest; and an updating module for updating the current software program is not the newest; and an updating module for updating the current software program to the newest version.

To accomplish the second above-mentioned objective, a method for automatically updating a version of a software program in a client computer is provided herein. The method comprises the steps of: (a) operating a software program in a client computer; (b) sending an inquiry about a version status of the software program; (c) obtaining a current version number of the software program; (d) comparing the current version number with a corresponding version number listed in a data list; (e) determining whether the current version of the software program is the newest according to the comparison result; (f) connecting to a file transfer protocol (FTP) server and obtaining the newest version of the software program from the FTP server, if the version of the software program is not the newest; and (g) updating the software program to the newest version.

These and other objectives, advantages and novel features of the present invention will be drawn from the following detail description of a preferred embodiment and a preferred method of the present invention with reference to the appended drawings, in which:

### BRIEF DESCRIPTION OF THE DRAWINGS

FIG. 1 is a block diagram of hardware infrastructure of a system for automatically updating versions of software programs in client computers according to the preferred embodiment of the present invention;

FIG. 2 is a schematic diagram of function modules of a version updating apparatus of an application server of the system of FIG. 1; and

FIG. 3 is a flowchart of the preferred method for automatically updating a version of a software program in a client computer by utilizing the system of FIG. 1.

### DETAIL DESCRIPTION OF THE PREFERRED EMBODIMENT

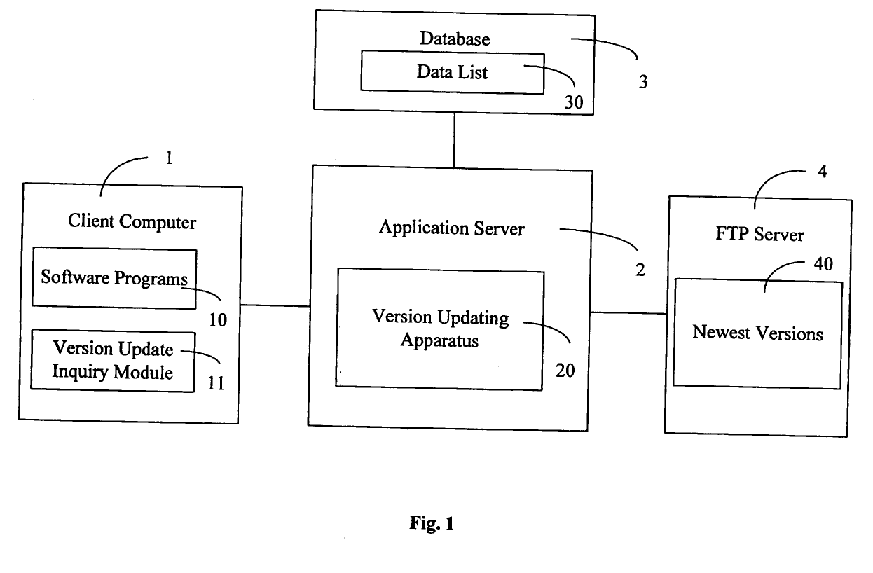

FIG. 1 is a block diagram of hardware infrastructure of a system for automatically updating versions of software programs in client computers (hereinafter “the system”) in accordance with the preferred embodiment of the present invention. The system comprises a plurality of geographically distributed client computers 1 (only one shown), an application server 2, a database 3, and a File Transfer Protocol (FTP) server 4. The client computers 1 and the FTP server 3 are connected to the application server 2 via one or more networks (not labeled). The networks may be any suitable communication architecture required by the system, such as one or more intranets and/or the Internet. Each client computer 1 has one or more computer-executable software programs 10 and a version update inquiry module 11 installed therein. According to the preferred embodiment, when any software program 10 in the client computer 1 is operated by a user, the version update inquiry module 11 of the client computer 1 is automatically invoked. The version update inquiry module 11 inquires about the version status of the software program 10 by sending an inquiry to the application server 2. The application server 2 responds to the inquiry, determines whether the version of the software program is the newest, and updates the software program to the newest version if the version of the software program is not the newest.

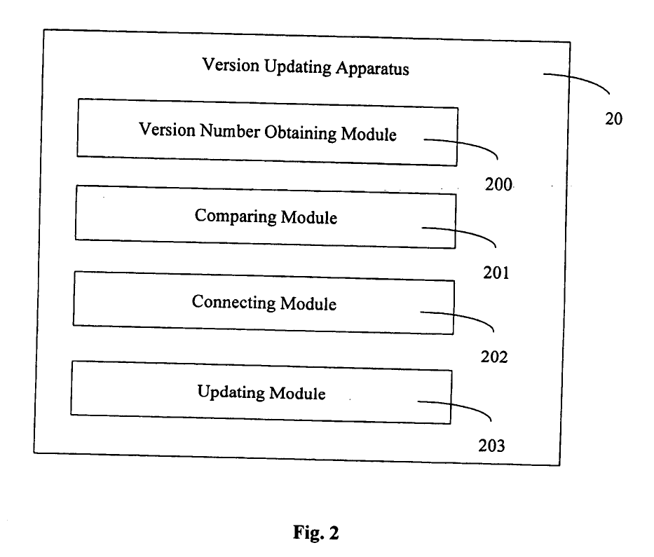

The FTP server 4 stores the newest versions 40 of the software programs 10. The database 3 is coupled to the application server 2 through a database connection (not labeled), and stores a data list 30 which contains version numbers of the newest versions 40 of the software programs 10. The application server 2 includes a version updating apparatus 20, which contains a number of function modules (described in detail below in relation to FIG. 2). When any client computer 1 inquires about a version status of a software program 10 operated therein, the version updating apparatus 20 determines whether the current version of the software program 10 is the newest, and updates the software program 10 to a corresponding newest version 40 stored in the FTP server 3 if the current version of the software program 10 is not the newest.

FIG. 2 is a schematic diagram of function modules of the version updating apparatus 20. The version updating apparatus 20 comprises a version number obtaining module 200, a comparing module 201, a connecting module 202, and an updating module 203. The version number obtaining module 200 is for obtaining a current version number of a software program 11 operated in the client computer 1. The comparing module 201 is for comparing the current version number of the software program 11 with a corresponding version number listed in the data list 30, to determine whether the current version of the software program 11 is the newest. The connecting module 202 is for automatically connecting the application server 2 to the FTP server 4 when the current version of the software program 11 is not the newest. The updating module 203 is for updating the software program 11 to the newest version 40 stored in the FTP server 4.

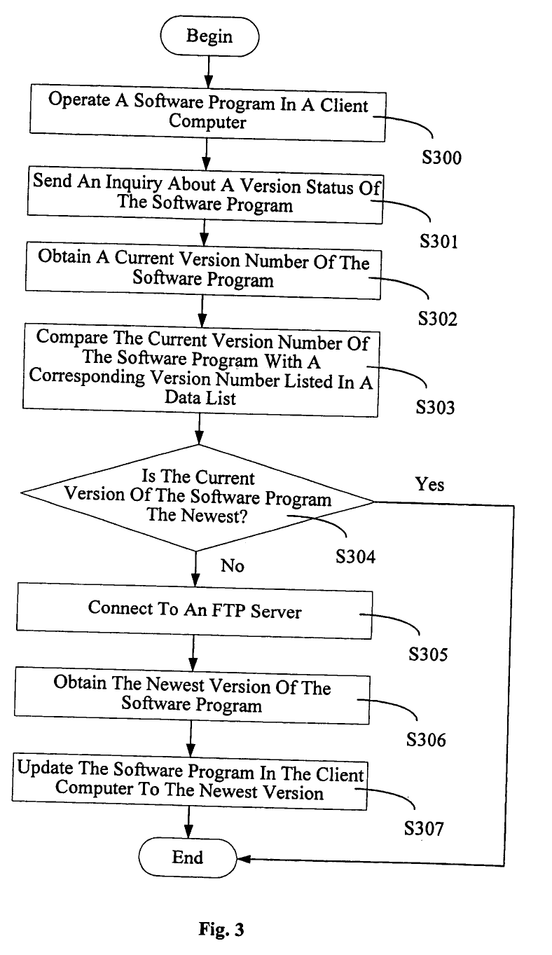

FIG. 3 is a flowchart of a preferred method for automatically updating a version of a software program 10 in a client computer 1 by utilizing the system. In step S300, the software program 10 is operated by a user in the client computer 1. In step S301, the version update inquiry module 11 sends an inquiry to the application server 2 about a version status of the software program 10. In step S302, the version number obtaining module 200 responds to the inquiry, and obtains a current version number of the software program 10. In step S303, the comparing module 201 compares the current version number of the software program 10 with a corresponding version number listed in the data list 30 stored in the database 3. In step S304, the comparing module 201 determines whether the current version of the software program 10 is the newest according to the comparison result. That is, whether the current version number of the software program 10 equals the version number in the data list 30. If the current version number equals the version number in the data list 30, this means that the current version of the software program 10 is the newest, whereupon the procedure is ended. If the current version number does not equal the version number in the data list 30, this means that the current version of the software program 10 is not the newest. Then in step S305, the connecting module 203 connects the application server 2 to the FTP server 4. In step S306, the connecting module 203 obtains the newest version 40 of the software program 10 from the FTP server 4. In step S307, the updating module 203 updates the software program 10 in the client computer 1 to the newest version 40 obtained from the FTP server 4.

Although the present invention has been specifically described on the basic of a preferred embodiment and a preferred method, the invention is not to be construed as being limited thereto. Various changes and modifications may be made to the embodiment and the method without departing from the scope and spirit of the invention.

1. A system for automatically updating versions of software programs in client computers, the system comprising an application server, a database, and a client computer, wherein:
the client computer comprises:
a plurality of software programs;
and a version update inquiry module for sending an inquiry to the application server about a version status of a software program operated in the client computer;
and the application server comprises:
a comparing module for comparing a current version number of the software program with a corresponding version number stored in the database, to determine whether the current version of the software program is the newest;

2. The system according to claim 1, wherein the database stores a data list which contains version numbers of the newest versions of the software programs.

3. The system according to claim 1, wherein the application server further comprises a version number obtaining module for obtaining a current version number of the software program operated in the client computer.

4. The system according to claim 1, wherein the application server further comprises a connecting module for connecting the application server to a server and obtaining the newest version of the software program when the current version of the software program is not the newest.

5. The system according to claim 1, wherein the application server further comprises an updating module for updating the software program to the newest version.

6. The system according to claim 4, wherein the server stores the newest versions of the software programs.

7. A method for automatically updating a version of a software program in a client-computer, the method comprising the steps of:
operating a software program in the client computer;
inquiring about a version status of the software program;
obtaining a current version number of the software program;
comparing the current version number with a corresponding version number listed in a database;
determining whether the current version of the software program is the newest according to the comparison result;
connecting to a server and obtaining the newest version of the software program from the server if the version of the software program is not the newest;
and updating the software program to the newest version.

8. The method according to claim 7, wherein the database stores a data list.

9. The method according to claim 8, wherein the corresponding version number are listed in the data list.

10. The method according to claim 7, wherein the server stores newest versions of various software programs.

11. A method for automatically updating versions of a software program in a computer system, comprising the steps of:
retrieving a version inquiry of said software program from said computer system in case that said software program is in use;
identifying a currently available version of said software program;
providing necessary downloads to said computer system in case that said currently available version of said software program is not available in said computer system based on said version inquiry;
and updating said software program based on said downloads.

12. The method according to claim 11, wherein said downloads are provided to said computer system by an application server used to identify said currently available version of said software program and decide necessity of said downloads.
